(19) United States
(12) Patent Application Publication
(10) Pub. No.: US 2026/0327421 A1
(43) Pub. Date: Oct. 22, 2026

(54) ENZYME-CONTAINING MULTILAYER ARTICLE HAVING WATER BARRIER PROPERTIES

(71) Applicant: CARBIOLICE, Clermont-Ferrand (FR)

(72) Inventor: Vincent LEGRAND, Combronde (FR)

(21) Appl. No.: 19/108,802

(22) PCT Filed: Sep. 14, 2023
(86) PCT No.: PCT/EP2023/075348

§ 371 Date: Mar. 5, 2025

(30) Foreign Application Priority Data
Sep. 14, 2022 (FR) FR2209254

(51) Int. Cl. C08L 67/04; B32B 27/08; B32B 27/36; B65D 65/40; B65D 65/46; C08K 11/00; C08L 67/02

(52) U.S. Cl. CPC C08L 67/04; B32B 27/08; B32B 27/36; B65D 65/40; B65D 65/466; C08K 11/00; C08L 67/02; B32B 2250/24; B32B 2307/7244; B32B 2307/7376; C08L 2201/06; C08L 2203/16; C08L 2205/025; C08L 2205/035

(57) ABSTRACT

The present invention relates to an enzyme-containing biodegradable multilayer article having water-barrier properties.

### FIELD OF THE INVENTION

The present invention relates to a biodegradable multilayer article made of plastics material having water-barrier properties, wherein at least one of the layers contains PLA as biodegradable polymer and enzymes capable of degrading it.

### PRIOR ART

Biosourced biodegradable articles are known, in particular single-layer or multilayer articles, used in the bag-making field, and in particular for manufacturing bags made from plastics material. These bags are in particular used for packaging food products, in particular fruits and vegetables.

Mention will be made in particular of the articles described in the patents and patent applications WO 2020/193770, WO 2007/118828, WO 2002/059202A1, WO 2002/059199, WO 2002/059198, WO 2004/052646, WO 2018/233888, U.S. Pat. Nos. 6,841,597, 8,751,816, 5,436,078, 9,096,758, US 2009/324917 and CN 106881929. However, these articles do not have water-barrier properties for food-packaging applications.

The method for producing an article comprising enzymes capable of degrading the polymers that make it up must both make it possible to preserve the enzymes during the preparation of said article, for example via mixtures with polymers that melt at temperatures that do not degrade said enzymes, and respect the physical-property constraints.

Improving, simply and economically, the water-barrier property of an enzyme-containing biodegradable article is all the more difficult to achieve since this must not be done to the detriment of the activity of the enzymes on the degradation of the degradable polyester.

Consequently it is necessary to propose solutions making it possible to improve the water-barrier properties of an article made from plastics material without being detrimental to the biodegradability thereof, and this in a simple, economical and efficient manner.

This objective, among others, is achieved by the novel composition of the biodegradable multilayer article according to the invention, which offers numerous advantages, in particular having water-barrier properties.

This is because the inventors have discovered that a particular mixture of polymers makes it possible to improve the water-barrier properties of a multilayer article made from biodegradable plastics material comprising enzymes and to respect the physical-property constraints of the articles made with this mixture.

### SUMMARY OF THE INVENTION

The invention relates to a multilayer biodegradable article of the AB, ABA, ABC, BAB, BAC, ABCA BACB, BCACB or ACBCA type, wherein:
the composition of the layer A comprises at least PHA (polyhydroxyalkanoate) in a quantity below 60% and PLA (polylactic acid);
the composition of the layer B comprises at least one thermoplastic polymer; and
the composition of the layer A and/or of the layer B comprises at least 0.001% enzymes capable of degrading said PLA;
   the percentages being given by weight with respect to the total weight of the composition of each layer.

According to one embodiment of the invention, the polymer constituting the layer B comprises at least one polyester selected from polyesters such as PLA (polylactic acid), PBAT (polybutylene adipate terephthalate), PHA (polyhydroxyalkanoate), PBS (polybutylene succinate), PCL (polycaprolactone), PBSA (polybutylene succinate adipate) and mixtures thereof in any proportions, preferably a mixture of PLA, PHA and PBAT.

The article according to the invention relates to a flexible article made from plastics material, in particular a plastic film, or a rigid article made from plastics material, in particular a sheet.

The flexible article according to the invention preferentially has a thickness ranging from 20 to 100 μm, preferably from 25 to 80 μm, more preferentially from 30 to 60 μm, even more preferentially approximately 50 μm.

The rigid article according to the invention has a thickness of between 150 and 5000 μm, preferentially between 400 and 500 μm, more preferentially equal to approximately 450 μm.

The invention also relates to a film comprising a multilayer article according to the invention, preferably a flexible multilayer article according to the invention.

The invention also relates to a sheet comprising a multilayer article according to the invention, preferably a rigid multilayer article according to the invention.

The multilayer article according to the invention can be used for preparing a package, a cap, a beaker, a plate, a drinks cap, a tray or a blister pack.

### DETAILED DESCRIPTION

### Definitions

The present invention will be understood better with reference to the following definitions.

Multilayer thermoplastic article of the type AB, ABA, ABC, BAB, BAC, ABCA, BACB, BCACB or ACBCA means, according to the invention, an article the layers of which are bonded together and not simply associated by simple juxtaposition. In particular and preferably, the layers are bonded by coextrusion. For example, article of the ABA type means an article comprising a middle layer B framed by two adjacent layers A. The two layers A preferably have the same composition. According to some embodiments of the invention, the multilayer article may comprise one or two layers C between the layers A and B to provide particular properties for the articles according to the invention, more particularly for providing barrier properties for gas and in particular oxygen. By way of example, the article ABCA or ACBCA comprises a layer C between the outer layer A and the middle layer B.

‘Article made from plastics material’ according to the invention designates any article produced from at least one polymer, such as a sheet, film, tube, rod, profiled member, shape, solid block, fibre, etc, made from plastics material.

The term ‘plastic film’ or ‘film made from plastics material’ refers to a flexible plastic film (i.e. capable of being folded without breaking) with a thickness of less than 250 μm. Thin films are considered to have a thickness of less than 100 μm and preferably produced by extruding blown film while thick films have a thickness greater than 100 μm and preferably produced by extruding cast film.

According to the invention, the term ‘rigid article’ or ‘rigid article made from plastics material’ refers to a plastic article that is not a film. These articles are preferably produced by injection, thermoforming, blow moulding or by rotary moulding or 3D printing.

As used here, the term ‘masterbatch’ designates a concentrated mixture of selected ingredients (for example enzymes, additives, etc) and a supporting polymer that can be used for introducing said ingredients into articles made from plastics material in order to confer the required properties thereon. The compositions of the masterbatch enable the method to economically introduce selected ingredients in the course of the process of manufacturing the plastics material. Advantageously, the masterbatch is composed of a supporting polymer in which the selected ingredients are incorporated at a high concentration. Generally, the masterbatch is intended to be mixed with one or more polymers or a polymer-based matrix to produce a final article made from plastics material containing a required quantity of selected ingredients. The masterbatch may furthermore comprise mineral or organic fillers.

Unless indicated to the contrary, the relative percentages and ratios are expressed by mass with respect to the total mass of the composition of the article.

It is specified that the expressions ‘from . . . to . . . ’ and ‘lying between . . . and . . . ’ used in the present description must be understood as including the bounds mentioned. On the other hand, the expressions ‘greater than . . . ’, ‘less than . . . ’, ‘more than . . . ’ and ‘less than . . . ’ used in the present description do not include the bounds mentioned.

In the context of the invention, the term ‘approximately’ refers to a margin of +/−5%, preferably +/−1%, or within the tolerance of a suitable measuring device or instrument.

In the context of the invention, the expressions ‘layer A’, ‘layer B’ and ‘layer C’ are respectively interchangeable with the expressions ‘composition of the layer A’, ‘composition of the layer B’ and ‘composition of the layer C’.

### Composition of the Articles

The article according to the invention is a multilayer thermoplastic article of biodegradable plastics material of the type AB, ABA, ABC, BAB, BAC, ABCA, BACB, BCACB or ACBCA, wherein:
the composition of the layer A (also referred to as layer A in the present description) comprises at least PHA (polyhydroxyalkanoate) in a quantity of less than 60% and PLA (polylactic acid);
the composition of the layer B (also referred to as layer B in the present description) comprises at least one thermoplastic polymer, preferably a polyester; and
the composition of the layer A and/or of the layer B comprises at least 0.001% enzymes capable of degrading said PLA;
   the percentages being given by weight with respect to the total weight of the composition of each layer.

Without being bound by any theory, it appears that the PHA, present in the composition in a quantity of less than 60% by weight with respect to the total weight of the composition of the layer A with PLA and at least one thermoplastic polymer, exerts, in an enzyme-containing multilayer article, an exacerbated water-barrier function.

### Composition of Layer A:

According to the invention, the PHA (polyhydroxyalkanoate) polymers are biodegradable polymers and a large number of them are produced on an industrial scale by bacterial fermentation methods or isolated from vegetable matter such as maize, sweet potatoes, etc. The PHA polymers may also be polycondensates of one or more hydroxyalkanoic acids. Examples of such hydroxyalkanoate acids that can be included in the PHA polymer are glycolic acid, hydroxypropanoic acid (also known by the name lactic acid), hydroxybutyric acid, hydroxyisobutanoic acid, hydroxypentanoic acid (also known by the name hydroxyvaleric acid), hydroxyhexanoic acid (also known by the name polycaprolactone, PCL), hydroxyheptanoic acid, hydroxyoctanoic acid, hydroxydecanoic acid, hydroxydodecanoic acid, hydroxytetradecanoic acid, or combinations of two or more of these.

Mention can be made, by way of examples, of PHAs such as PHBV (poly(3-hydroxybutyrate-co-3-hydroxyvalerate)), PHBH (poly(3-hydroxybutyrate-co-3-hydroxyhexanoate)), PHB (poly-β-hydroxybutyrate), PHH (polyhydroxyhexanoate), P3HP (poly(3-hydroxypropionate)), P3HB (poly(3-hydroxybutyrate)), P4HB (poly(4-hydroxybutyrate)), P4HV (poly(4-hydroxyvalerate)), P5HV (poly(5-hydroxyvalerate)), PHB3HP (poly(3-hydroxybutyrate-co-3-hydroxypropionate)), P3HB4HB (poly(3-hydroxybutyrate-co-4-hydroxybutyrate)), PHB4HV (poly(3-hydroxybutyrate-co-4-hydroxyvalerate)), PHB3HV (poly(3-hydroxybutyrate-co-3-hydroxyvalerate)), PHB3HH (poly(3-hydroxybutyrate-co-3-hydroxyhexanoate)), PHB5HV (poly(3-hydroxybutyrate-co-5-hydroxyvalerate)) and mixtures thereof in any proportions. Preferably, the PHA is selected from PHBV or PHBH.

Advantageously, the PHA content in the layer A is between 5% and 50%, preferably between 10% and 45%, more preferentially between 20% and 40%, even more preferentially between 20% and 35% by weight with respect to the total weight of the composition of the layer A. According to some embodiments of the invention, the PHA content in the layer A is equal to approximately 10%, 15%, 20%, 25%, 30%, 35%, 40%, 45% and 50% by weight with respect to the total weight of the composition of the layer A.

According to a preferred embodiment, the PHA content in the layer A is equal to approximately 25% by weight with respect to the total weight of the composition of the layer A.

Advantageously, the PLA content in the layer A is between 2% and 90% by weight, preferably between 3% and 80%, between 4% and 70%, between 5% and 60%, more preferentially between 5% and 40%, even more preferentially between 10% to 40% by weight with respect to the total weight of the composition of the layer A.

The layer A can furthermore comprise PHA and PLA, complementary polyesters that are biodegradable polyesters well known to a person skilled in the art. Complementary polyester means additional biodegradable polyesters different from PHA and PLA included in the composition of the layer A. These ‘complementary polyesters’ are in particular selected from PBAT (polybutylene adipate terephthalate), PBS (polybutylene succinate), PCL (polycaprolactone) and PBSA (polybutylene succinate adipate), plasticised starch and mixtures thereof in any proportions.

Preferably the complementary polyester content in the layer A is between 10% and 90% by weight, preferably between 20% and 80%, more preferentially between 30 and 75%, even more preferentially 40% and 70% by weight with respect to the total weight of the composition of layer A.

According to a particular embodiment, the complementary polyester is PBAT.

According to a preferred embodiment, the layer A comprises a mixture comprising PHA, PBAT, PBAT being the complementary polymer, and PLA.

### Composition of the Layer B:

The layer B comprises one or more thermoplastic polymers constituting this layer. According to a preferred embodiment of the invention, this or these constituent polymers are one or more polyesters selected from polyesters such as PLA (polylactic acid), PBAT (polybutylene adipate terephthalate), PHA (polyhydroxyalkanoate), PBS (polybutylene succinate), PCL (polycaprolactone), PBSA (polybutylene succinate adipate) and mixtures thereof in any proportions.

The polymer or polymers constituting the layer B can also be selected from barrier materials such as PVOH (polyvinyl alcohol), PVCD (polyvinyl chloride), PGA (polyglycolic acid), cellulose and derivatives thereof, or polysaccharides and mixtures thereof, employed alone or in mixtures with the aforementioned polyesters.

According to a particular embodiment of the invention, the polymer constituting the layer B according to the invention is selected from PLA, PHA and PBAT and mixtures thereof in any proportions.

According to a preferred embodiment, the polymers constituting the layer B are a mixture of PLA, PBAT and PHA.

According to another preferred embodiment, the polymers constituting the layer B are a mixture of PLA and PBAT.

Advantageously, the PHA content, when it is present alone or in a mixture with one or more other aforementioned polyesters in the layer B, is as defined above for the layer A. Preferably, the PHA content in the layer B is equal to 10%, 15%, 20%, 25%, 30%, 35%, 40%, 45%, 50% and 55%, the percentages being expressed by weight with respect to the total weight of the composition of the layer B.

In a particular embodiment, the PHA content of the layer B is equal to 100% by weight with respect to the total weight of the composition of the layer B.

Advantageously, the PLA content, when it is present alone or in a mixture with one or more other aforementioned polyesters in the layer B, is as defined above for the layer A.

Advantageously, the PBAT content, when it is present alone or in a mixture with one or more other aforementioned polyesters in the layer B, between 5% to 95%, preferably between 20% and 80%, more preferentially 40% and 75% by weight with respect to the total weight of the composition of the layer B.

Layer A and/or Layer B

According to the invention, the layer A and/or the layer B comprises at least 0.001% by weight enzymes capable of degrading the PLA of the layer A and where applicable of the layer B, whether they be adjacent or separated by a layer C. It is understood that the enzyme content is expressed by weight with respect to the total weight of the composition of the layer A and/or B depending on whether the enzymes are present in the layer A and/or the layer B.

The enzymes capable of degrading the PLA used in the context of the present invention are well known to a person skilled in the art. Mention will be made in particular of enzymes capable of degrading PLA so as to improve the biodegradability of the article according to the invention. Such enzymes and the method for incorporating same in thermoplastic articles are known to a person skilled in the art, in particular described in the patent applications WO 2013/093355, WO 2016/198652, WO 2016/198650, WO 2016/146540 and WO 2016/062695. Preferentially these enzymes are selected from proteases and serine proteases. In a particular embodiment, the serine proteases are selected from the Proteinase K of Tritirachium album, or the enzymes degrading PLA coming from Amycolatopsis sp., Actinomadura keratinilytica, Laceyella sacchari LP175, Thermus sp., or Bacillus licheniformis, or reformulated commercial enzymes known for degrading PLA such as Savinase®, Esperase®, Everlase® or any enzyme in the family of subtilisins CAS 9014-01-1 or any functional variant.

A person skilled in the art will adapt the enzyme content in the layer A and/or the layer B according to their objectives of degrading the PLA of the layer A and/or B that frame it.

Advantageously, the enzyme content in the layer A and/or the layer B will be at least 0.002%, or advantageously at least 0.05% by weight with respect to the total weight of the composition of the layer A and/or B. These proportions can range up to 10% by weight with respect to the total weight of the composition of the layer A and/or B, or even more. Although it is possible to formulate compositions comprising more than 10% enzymes, it is nevertheless rare for such proportions to be exceeded for the most frequent usages of articles made from plastics material according to the invention. Advantageously, the enzyme content in the composition of the layer A and/or the layer B is 0.01 to 7%, preferably from 0.02 to 5% by weight with respect to the total weight of the composition of the layer A and/or B.

According to a particular embodiment of the invention, the multilayer article comprises, by weight with respect to the total weight of the composition of the article:
10% to 35% PHA, preferably between 12.5 and 25%
10% to 50% PLA, preferably between 15 and 30%
50% to 60% PBAT, preferably between 52 and 56%
at least 0.001% enzymes capable of degrading said PLA, and
optionally, 0.8% to 8% a supporting polymer such as PCL or PBSA, preferably 4%.

According to a preferred particular embodiment of the invention, the article comprises, by weight with respect to the total weight of the composition of the article:
10% to 35% PHA, preferably between 12.5 and 25%
10% to 50% PLA, preferably between 15 and 30%
50% to 60% PBAT, preferably between 52 and 56%
0.8% to 8% PCL, preferably 4%
at least 0.001% enzymes capable of degrading said PLA.

According to another preferred particular embodiment of the invention, the article comprises, by weight with respect to the total weight of the composition of the article:
10% to 35% PHA, preferably between 12.5 and 25%
10% to 50% PLA, preferably between 15 and 30%
50% to 60% PBAT, preferably between 52 and 56%
0.8% to 8% PBSA, preferably 4%
at least 0.001% enzymes capable of degrading said PLA.

According to the invention, the layer A and/or the layer B can furthermore comprise usual additives used in preparing plastic articles, such as slip additives, plasticisers, nucleating agents, compatibility agents, manufacturing aids, UV radiation stabilisers, impact-protection agents, mineral or vegetable fillers, etc. According to a preferred embodiment, the usual additives are employed in the layer A of the article.

Advantageously, the proportion of usual additives in the multilayer article according to the invention is at least 0.2%, preferably from 1 to 5%, more preferentially from 2 to 4%, advantageously approximately 2% by weight with respect to the total weight of the composition of the article.

According to a preferred embodiment, the layer A and/or the layer B of the multilayer article furthermore comprises one or more slip additives, such as oleamide, erucamide, stearamide, behenamide, oleyl palmitamide, stearyl erucamide, ethylene bis-oleamide, EBS or a mixture thereof. Preferably, the slip additive is oleamide.

The article can also comprise plasticisers. The plasticisers used in the article of degradable plastics material are well known to persons skilled in the art. They are in particular selected from polyols and amides, lactic acid oligomers (OLAs) and citrate esters.

OLAs are plasticisers known to persons skilled in the art, in particular as biosourced materials. It is a case of lactic acid oligomers with a molecular weight of less than 1500 g/mol. They are preferably esters of lactic acid oligomers, the carboxylic acid termination thereof being blocked by esterification with an alcohol, in particular a C1-C10 linear or branched alcohol, advantageously a C6-C10 alcohol, or a mixture thereof. Mention will be made in particular of the OLAs described in the patent application EP 2 256 149 with the method for preparing same, and the OLAs marketed by the company Condensia Quimica under the tradename Glyplast®, in particular the references Glyplast® OLA 2, which has a molecular weight of 500 to 600 g/mol, and Glyplast® OLA 8, which has a molecular weight of 1000 to 1100 g/mol. According to a preferred embodiment of the invention, the OLAs have a molecular weight of at least 900 g/mol, preferably 1000 to 1400 g/mol, more preferentially from 1000 to 1100 g/mol.

Citrate esters are also plasticisers known to a person skilled in the art as biosourced materials. Mention will be made in particular of triethyl citrate (TEC), triethyl acetate citrate (TEAC), tributyl citrate (TBC) and tributyl acetal citrate (TBAC), preferably TBAC.

Compatibility agents may form part of the composition of the multilayer article according to the invention. Of such compatibility agents, PLA/polyesters are well known to persons skilled in the art, in particular the molecules having the epoxy, acrylate, anhydride, oxazoline and lactam functions that allow grafting reactions.

Among the compatibility agents, mention will be made more particularly of polyacrylates, ethylene, acrylic ester and glycidyl methacrylate terpolymers (for example marketed under the trade mark Lotader® by the company Arkema), PLA-PBAT-PLA triblock copolymers, PLAs grafted with maleic anhydride (PLA-g-AM) or PBATs grafted with maleic anhydride (PBAT-g-AM).

Mineral and/or vegetable fillers can also be used in the composition of the multilayer article of the invention, the mineral fillers preferentially used are calcium carbonate or talc.

The vegetable fillers preferentially used are starch and wood fibres and flour.

### Composition of Layer C:

The barrier materials constituting the layers C are well known to persons skilled in the art, and in particular PVOH (polyvinyl alcohol), EVOH (poly(vinyl alcohol-co-ethylene)), PVCD (polyvinyl chloride), PGA (polyglycolic acid), cellulose and derivatives thereof, or polysaccharides and mixtures thereof in any proportions, cited above for those that may also form part of the composition of the layer A and/or the layer B.

The PVOH used as barrier material in preparing the article is well known. It is a case of polyvinyl alcohol the degree of polymerisation of which is between 300 and 2500. The melting point thereof is below 210° C. and the viscosity thereof is between 3 and 60 mPa·s.

The PVCD used as barrier material in preparing the article is well known. It is a case of polyvinylidene chloride resulting from the copolymerisation of vinylidene chloride (85%) and vinyl chloride (15%).

The PGA used as barrier material in preparing the article corresponds to polyglycolic acid, the melting point of which is 220° C. and the glass transition temperature of which is 40° C.

Among celluloses, mention will be made more particularly of microfibril celluloses (MFCs) and cellulose acetate.

The MFCs used as barrier material have a diameter of between 4 and 10,006 nanometres and a density of between 0.51 and 1.57 g/cm³.

The polysaccharides used as barrier materials are also well known to persons skilled in the art. Mention will be made more particularly of galactomannans, pectin or soluble soya polysaccharides, marine extracts such as carrageenans and alginates, and microbial or animal polysaccharides such as gellans, dextrans, xanthans, xylans or chitosan, and mixtures thereof.

Advantageously, the proportion of biosourced material for producing the article according to the invention is greater than 30%, preferentially greater than 40%.

As with the layer A and/or the layer B, the layer C can also comprise additives usual in preparing plastic articles, such as defined previously.

According to a preferred embodiment of the invention, the composition of the layer C is as follows
90 to 100% barrier materials as defined previously, and
0 to 10% additives,
   the percentages being expressed by weight with respect to the total weight of the composition of the layer C.

Preferably, the layer C comprises more than 95% barrier material by weight with respect to the total weight of the composition of the layer C, even more preferentially 99% or more.

PVOH is a preferred barrier material for the layers C of the articles according to the invention.

### Articles

According to the invention, the article made from plastics material is a manufactured product, such as rigid or flexible packaging, agricultural films, sachets and bags, disposable articles or the like. Preferably, the article is made from thermoplastic material. The plastic articles according to the invention may contain supplementary substances or additives, such as slip additives, plasticisers, or mineral or inorganic fillers.

The multilayer article according to the invention advantageously has a thickness greater than or equal to approximately 20 μm, preferably greater than or equal to approximately 25 μm, more preferentially greater than or equal to approximately 50 μm, more preferentially greater than or equal to approximately 450 μm, more preferentially greater than 750 μm, preferentially less than 5000 μm.

According to the invention, the article made from plastics material can be selected from a flexible article made from plastics material or a rigid article made from plastics material.

According to one embodiment, the multilayer article according to the invention is a flexible article, in particular a plastic film.

The multilayer article according to the invention advantageously has a thickness of less than 250 μm, preferentially ranging from 20 to 100 μm, preferably from 25 to 80 μm, more preferentially from 30 to 60 μm, even more preferentially approximately 50 μm.

Among the examples of plastic films, mention can be made of agricultural films, plastic bags or sachets, films for flexible packaging, food films, caps, blister packs, mailing films, dispatching films, mulching films, liner or covering films, multipack films, industrial films, personal care films, nets, etc.

The multilayer article according to the invention also relates to a film comprising a flexible multilayer article, preferably a multilayer article as defined above.

According to another embodiment, the multilayer article according to the invention is a rigid article.

Examples of articles made from rigid plastic material are thin-wall packages such as packages for food and drinks, boxes, plates, containers, restaurant articles, electronic boxes, cosmetic cases, outdoor gardening articles such as pots, rigid packaging, containers, beakers, plates, drinks caps, trays, blister packs, cards, cotton buds, pipe irrigation products, etc. Some articles made from rigid plastic material can be produced by thermoforming plastic sheets with a thickness of 150 μm or more, these plastic sheets being produced by film casting or calendering.

The multilayer rigid article according to the invention advantageously has a thickness greater than 150 μm, preferentially less than 5000 μm.

According to a preferred embodiment of the invention, the thickness of the multilayer article ranges from 150 to 3000 μm.

The invention also relates to a sheet comprising a multilayer article according to the invention, preferably a rigid multilayer article as defined previously.

Advantageously, the thickness of the multilayer rigid article is less than 5000 μm, preferably between 400 and 800 μm, preferably between 400 and 500 μm, more preferentially equal to approximately 450 μm. Alternatively, the thickness of the multilayer rigid article is equal to approximately 750 μm.

According to some preferred embodiments, the multilayer article is of the ABA or BAB type. Preferably, the multilayer article is of the ABA type.

The relative thickness of each layer of the article AB, ABA, ABC, BAB, BAC, ABCA BACB, BCACB or ACBCA according to the invention can vary according to the final properties sought for the article, in particular in terms of water-barrier property but also in terms of biodegradability. According to one embodiment of the invention, the thickness of the layer A or B is between 10 and 725 μm, between 18 and 30 μm, preferably equal to approximately 25 μm.

Advantageously, each layer A represents independently from 5 to 30% of the total thickness of the article and the middle layer B represents from 40 to 90% of the total thickness of the article. Preferably, the middle layer B represents from 50 to 90% of the total thickness of the article.

In a preferred embodiment of the flexible article of the invention, the two layers A have identical thicknesses, each representing from 15 to 30% of the total thickness of the article, preferentially from 16 to 25%.

In a preferred embodiment of the rigid article of the invention, the two layers A have identical thicknesses, each representing from 2 to 20% of the total thickness of the article, preferentially from 3 to 15%.

According to some embodiments of the invention, the flexible multilayer article is of the type AB, ABA, ABC, ABCA, ACBCA and wherein each layer A represents from 15 to 30% of the total thickness of the film and the middle layer B represents from 40 to 70% of the total thickness of the article.

According to some embodiments, the flexible multilayer article is of the type AB, BAB, BAC, BACB or BCACB and wherein each layer B represents from 15 to 30% of the total thickness of the film and the middle layer A represents from 40 to 70% of the total thickness of the film.

The layers C when present generally have a thickness of less than 15 μm. They represent individually less than 15% of the total thickness of the article.

According to a particular embodiment of the invention, the layers C, when present, of the multilayer flexible articles have a thickness of less than 3 μm. They represent individually less than 30% of the total thickness of the article.

According to a particular embodiment of the invention, the layers C, when present, of the multilayer rigid articles have a thickness of less than 20 μm. They represent individually less than 30% of the total thickness of the article.

The multilayer article of the invention can also be applied on a support of a different nature, such as a biodegradable film, a paper or other. For example, the multilayer article of the invention can be glued by lamination on a biodegradable film to reinforce the water-barrier properties thereof.

### Preparation of the Article

Another object of the invention relates to a method for preparing a multilayer article according to the invention. The compositions of the layers A, B and C are prepared by the usual techniques for preparing polymer compositions. The articles are prepared by mixing various constituents, and then forming the article according to the required form, flexible or rigid article.

According to the invention, the enzymes having an activity of degrading PLA are added in a suitable form for allowing a homogeneous dispersion of said enzymes in the multilayer article. These enzymes can be added directly to the polymers of the layer A and/or of the layer B during preparation thereof, or in the form of a concentrated pre-mixture in a supporting polymer with a low melting point.

According to a particular embodiment of the multilayer article according to the invention, the method comprises the following steps:
a) Providing enzymes having an activity of degrading polyester in a suitable form for allowing a homogeneous dispersion of said enzymes in the multilayer article, said form being selected from
   a liquid composition comprising the enzymes having an activity of degrading PLA, water and optionally a polysaccharide support, or
   a masterbatch comprising the enzymes having an activity of degrading PLA and a supporting polymer having a melting point below 140° C. and/or a glass transition temperature below 70° C., and
b) mixing the enzymes having an activity of degrading PLA provided at step (a) with the polymers of the layer A and/or the layer B, and
c) forming the article.

A person skilled in the art will know how to prepare the multilayer article according to the invention, by any usual techniques that allow bonding, such as coextrusion, co-injection or lamination. Preferably, the article is prepared by coextrusion of the layers, a person skilled in the art being able to determine the conditions for implementing the method, and in particular mixing the components forming part of the composition of each of the layers. Advantageously, the coextrusion is implemented at a temperature below 200° C.

According to a first embodiment, the enzymes are added in the form of a liquid composition comprising the enzymes having an activity of degrading PLA, water and optionally a polysaccharide support. Such compositions and use thereof for preparing enzyme-containing polymer mixtures are described in particular in the applications WO 2019/043145 and WO 2019/043134.

The proportion of enzymatic composition in the layer A and/or B will depend in particular on the proportion of enzymes in the enzymatic composition and the enzyme proportion sought for the article. According to a particular embodiment, from 1 to 10% by weight with respect to the total weight of the composition of the multilayer article will be used.

According to a second embodiment, the enzymes are provided by a masterbatch.

The masterbatch is a concentrated pre-mixture of enzymes and a supporting polymer.

The supporting polymer is a polymer having a melting point below 140° C. and/or a glass transition temperature below 70° C.

Polymers having a melting point below 140° C. and/or a glass transition temperature below 70° C. are well known to a person skilled in the art. It is a case in particular of polycaprolactone (PCL), polybutylene succinate adipate (PBSA), polybutylene adipate terephthalate (PBAT), polyhydroxyalkanoate (PHA), polylactic acid (PLA), or copolymers thereof. It may also be a case of a natural polymer such as starch or a polymer that will be termed universal, i.e. compatible with a wide range of polymers, such as a copolymer of the EVA type. Advantageously, the supporting polymer has a melting point below 120° C. and/or a glass transition temperature below 30° C.

The supporting polymer is preferably selected from PCL, PBSA, PBAT, PHA, PLA and mixtures thereof in any proportions, in particular PCL or even more preferentially PBSA.

Preferentially, the masterbatch also comprises a polysaccharide.

The polysaccharides are in particular selected from starch derivatives such as amylose, amylopectin, maltodextrin's, glucose syrup, dextrins and cyclodextrins, natural gums such as gum arabic, tragacanth gum, guar gum, locust bean gum, karaya gum, mesquite gum, galactomannans, pectin or soluble soya polysaccharides, marine extracts such as carrageenans and alginates, and microbial or animal polysaccharides such as gellans, dextrans, xanthans or chitosan, and mixtures thereof. A preferred polysaccharide is gum arabic.

In this case, the composition of the multilayer article according to the invention will also comprise a polysaccharide.

A preferred composition of a masterbatch comprises from 50 to 95% a polymer with a low melting point, in particular polycaprolactone (PCL) or even more preferentially PBSA, preferentially from 70 to 90%, from 0.001 to 10% enzymes, preferentially from 1 to 6%, and from 1 to 30% gum arabic, preferentially from 10 to 25%, the percentages being expressed by weight with respect to the total weight of the composition of the masterbatch.

Such masterbatches and the methods for preparing same are described in particular in the patent applications WO 2019/043134 and WO 2021/148665 or in the French patent application No 2107809 filed on 20 Jul. 2021.

According to a particular embodiment of the invention, the article comprises:
from 80 to 99% constituent polymer, preferably from 90 to 99%
from 0 to 40% polysaccharide, preferably from 0.1 to 4%
from 0 to 40% a supporting polymer, preferably from 3 to 6%, and
from 0.005 to 10% enzymes, preferably from 0.01 to 5%, more preferentially from 0.01 to 3%,
   the percentages being expressed by weight with respect to the total weight of the composition of the article.

According to a more particular embodiment, the proportion of enzyme in the above composition ranges from 0.02 to 1% by weight with respect to the total weight of the composition of the article.

According to another embodiment, the article is prepared by forming a pre-mixture or compound formed by the composition of the previously defined article.

The pre-mixture is prepared according to the method previously described, with for the forming step c) a granulation according to usual methods.

The invention therefore also relates to a pre-mixture in the form of granules comprising:
less than 60% PHA (polyhydroxyalkanoate),
PLA
at least 0.001% enzymes capable of degrading said polyester, and
at least one complementary thermoplastic polymer,
   in all the variant embodiments described previously for the article,
   and the percentages being expressed by weight with respect to the total weight of the composition of the pre-mixture.

According to a particular embodiment, the layer A and/or the layer B comprises, in addition to the polymers that constitute it, enzymes, a supporting polymer and a polysaccharide all as defined above.

According to a particular embodiment of the invention, the layer A or the layer B consists essentially of the above enzymatic composition (the supporting polymer is also the constituent polymer). The composition may be supplemented by usual additives described above.

According to a particular embodiment of the invention, the polymer or polymers constituting the layer B according to the invention have a melting point below that of the polymers constituting the layer A.

### Use of the Articles

The invention also relates to various uses of the multilayer articles obtained according to the invention, in particular flexible or rigid multilayer articles.

The multilayer article according to the invention can be employed for any normal usages of thermoplastic articles, and in particular for preparing packages or bags, or for mulching or dispatching. It can also be employed for preparing disposable crockery (plates, glasses), packages (trays, blister packs) or drinks caps.

The various embodiments, variants and preferences and the advantages described above for each of the objects of the invention apply to all the objects of the invention and can be taken separately or in combination.

The invention is illustrated by the following examples given non-limitatively.

### Examples

### I. Preparation of a Mix of Supporting Polymer and Enzyme

The mix of supporting polymer and enzyme is prepared from granules of polycaprolactone (PCL) and the enzyme in liquid form as described in the application WO 2019/043134.

The mix of supporting polymer and enzyme was manufactured with a CLEXTRAL EV25HT dual-screw extruder comprising 11 zones for which the temperature is independently controlled and regulated. The PCL is introduced into zone 1 at 16 kg/h and the enzyme solution in zone 5 at 4 kg/h using a peristaltic pump. The zones are heated in accordance with table [1]. 20% of the enzyme solution is introduced to the PCL (% by weight with respect to the total weight).

TABLE 1
Temperature profile (°C) used for
the supporting polymer and enzyme mix

| Zone | Z1 | Z2 | Z3 | Z4 | Z5 | Z6 | Z7 | Z8 | Z9 | Z10 | Z11 |
|---|---|---|---|---|---|---|---|---|---|---|---|
| Temperature | 40 | 65 | 75 | 75 | 60 | 60 | 60 | 60 | 60 | 60 | 60 |

### II. Commercial Products

In these examples of PHBV marketed under the reference ENMAT™ Y1000P by the company Helian Polymers, PHBH marketed under the reference Green Planet™ X128 by the company KANEKA, PLA/PBAT mixtures marketed under the references Ecovio® F2331, Ecovio® F2332, Ecovio® F2223 and a slip additive under the reference Ecoflex® SL-05 marketed by BASF, PLA marketed under the reference Luminy® LX175 by the company Total Corbion.

### III. Production of the Films

For preparing multilayer films, use is made of a Eurexma three-layer coextrusion inflation line, width 275-300 mm and screw L/D=30. The inflation rate was approximately 3.5-3.9. The settings and temperatures are detailed in tables [2] to [4].

TABLE 2
Process parameters for a 50 μm film with
an A/B/A 25/50/25 distribution of layers

| | | Temperature | | | | Die | | |
|---|---|---|---|---|---|---|---|---|
| | | Z1 | Z2 | Z3 | Z4 | Z1 | Z2 | DIE |
| A interior | Set | 165- | 165- | 165- | 170- | 140- | 140- | 140- |
| | Actual | 130 | 135 | 135 | 140 | 150 | 155 | 160 |
| B central | Set | 175- | 170- | 140- | 140- | | | |
| | Actual | 175 | 175 | 165 | 165 | | | |
| A exterior | Set | 175- | 170- | 140- | 140- | | | |
| | Actual | 175 | 175 | 165 | 165 | | | |

TABLE 3
Extruder method parameters

| | Internal | Central | External |
|---|---|---|---|
| | screw A | screw B | screw A |
| Screw speed (rpm) | 35 | 30 | 35 |
| Screw motor current (A) | 2.9 | 8 | 2.9 |
| Pressure (bar) | 60 | 80 | 45 |

TABLE 4
Extruder method parameters

| | |
|---|---|
| Drawing speed (m/min) | 2.5 |
| Spool speed (m/min) | 2.7 |
| Ventilation (rpm) | 60 |

### VI. Analysis Method

The water-barrier properties of the films were evaluated with a permeability test in accordance with the following protocol: films with dimensions 30×8 cm are folded in two in the direction of the length and welded on three ends to form a bag that is next filled with 20.0 g of water. The bag is next welded on its last side to form a hermetic pouch that is placed flat for 7 days. The mass of the bag is determined every day for one week in order to obtain a mean loss of water in g/d.

The biodegradability of the films was evaluated with a depolymerisation test implemented in accordance with the following protocol: 100 mg of each sample was introduced into a plastic vial containing 50 mL of buffer solution at pH 9.5. Depolymerisation is initiated by incubating each sample at 45° C., in an incubator stirred at 150 rpm. An aliquot of 1 mL of buffer solution is taken off regularly and filtered by means of a 0.22 μm filter syringe in order to be analysed by high-performance liquid chromatography (HPLC) with an Aminex HPX-87H column to measure the release of lactic acid (LA) and its dimer. The chromatography system used is an Ultimate 3000 UHPLC system (Thermo Fisher Scientific, Inc. Waltham, MA, USA) comprising a pump, an automatic sampler, a column thermostatically controlled at 50° C. and a 220 nm UV detector. The eluent is 5 mM H₂SO₄. The injection is 20 μL of sample. The lactic acid is measured using standard curves prepared using commercial lactic acid.

The hydrolysis of the plastic films is calculated from the lactic acid and the lactic acid dimer released. The percentage of depolymerisation is calculated after 7 days with regard to the percentage of PLA in the sample.

### Results

### VII. Composition of Films and Results

The films of the ABA type were prepared with the supporting polymer and enzyme mix prepared in I, PHA, PLA and a mixture of PLA/PBAT.

According to the following examples in accordance with the invention, the mix of supporting polymer and enzyme prepared in I is present either in layers A or in layer B or in the layers A and B.

The composition of the external layers A of films 11 to 17 furthermore contained 2% slip agent of the SL-05 stearate type.

The thickness of the films produced is 50 μm and the relative thicknesses of each layer A/B/A are 25%/50%/25%.

The compositions of these various films are set out in table [5] below.

TABLE 5
Compositions of these various films produced

| | Layer A (internal and external) | Layer B (middle) |
|---|---|---|
| Distribution | 25 | 50 |
| of layers % | | |
| Film 10 | Ecovio ® F2223 | Ecovio ® F2223 |
| Film 11 | 73% Ecovio ® F2331 + | 90% Ecovio ® F2223 + |
| | 25% ENMAT ™ Y1000P (PHBV) | 10% mix I |
| Film 12 | 73% Ecovio ® F2331 + | 65% Ecovio ® F2223 + |
| | 25% ENMAT ™ Y1000P (PHBV) | 25% ENMAT ™ Y1000P |
| | | (PHBV) + 10% mix I |
| Film 13 | 73% Ecovio ® F2331 + | 65% Ecovio ® F2332 + |
| | 25% ENMATTM Y1000P (PHBV) | 25% ENMATTM Y1000P |
| | | (PHBV) + 10% mix I |
| Film 14 | 73% Ecovio ® F2332 + | 65% Ecovio ® F2332 + |
| | 25% ENMATTM Y1000P (PHBV) | 25% ENMATTM Y1000P |
| | | (PHBV) + 10% mix I |
| Film 15 | 63% Ecovio ® F2223 + | 75% Ecovio ® F2331 + |
| | 25% ENMATTM Y1000P | 25% ENMATTM Y1000P (PHBV) |
| | (PHBV) + 10% mix I | |
| Film 16 | 68% Ecovio ® F2223 + | 70% Ecovio ® F2331 + |
| | 25% ENMATTM Y1000P | 25% ENMATTM Y1000P |
| | (PHBV) + 5% mix I | (PHBV) + 5% mix I |
| Film 17 | 63% Ecovio ® F2331 + | Ecovio ® F2223 + 15% |
| | 35% ENMATTM Y1000P (PHBV) | ENMATTM Y1000P (PHBV) + |
| | | 10% mix I |
| Film 18 | 75% Ecovio ® F2223 + | 65% Ecovio ® F2223 + |
| | 25% GREEN PLLANETTM | 25% Green PLlanet ™ X128 |
| | X128 (PHBH) | (PHBH) + 10% mix I |

Compositions with a proportion of pHA beyond 60% were difficult to extrude to obtain multilayer films and have a very sticky appearance of the material that destabilises the bubble and prevents sheaths from opening.

Film 10 is a comparative example.

The properties of films 11 to 18 prepared above were measured in accordance with the protocols defined above.

The results of these measurements are given in table 6 below.

TABLE 6
Results of measurements made

| | Biodegradability (% PLA | Water-barrier properties |
|---|---|---|
| Film | depolymerised after 7 days) | (loss of water) g/d |
| 10 | 0% | 1.8 |
| 11 | 1.5% | 0.40 |
| 12 | 3% | 0.33 |
| 13 | 3% | 0.25 |
| 14 | 1% | 0.27 |
| 15 | 30% | 0.61 |
| 16 | 30% | 0.80 |
| 17 | 5% | 0.35 |
| 18 | 1% | 0.60 |

It is thus demonstrated that the polymer mixture according to the invention relates to improved water-barrier properties compared with a film without PHA. PHBV makes it possible to improve the barrier properties in PLA/PHA mixtures more significantly than PHBH.

1. Biodegradable multilayer article of the AB, ABA, ABC, BAB, BAC, ABCA BACB, BCACB or ACBCA type, wherein
the composition of layer A comprises at least PHA (polyhydroxyalkanoate) in a quantity of less than 60% and PLA (polylactic acid);
the composition of the layer B comprises at least one thermoplastic polymer; and
the composition of the layer A and/or the layer B comprises at least 0.001% enzymes capable of degrading said PLA,
the percentages being given by weight with respect to the total weight of the composition of each layer.

2. Multilayer article according to claim 1, characterised in that the thermoplastic polymers of the composition of the layer B are polyesters chosen from PLA (polylactic acid), PBAT (polybutylene adipate terephthalate), PHA (polyhydroxyalkanoate), PBS (polybutylene succinate), PCL (polycaprolactone), PBSA (polybutylene succinate adipate) and mixtures thereof.

3. Multilayer article according to claim 1 or 2, characterised in that the proportion of PHA in the composition of the layer A is between 5% and 50% by weight, preferably between 10% and 45% by weight, more preferentially between 20% and 40%, even more preferentially between 20% and 35% by weight with respect to the total weight of the composition of the layer A.

4. Multilayer article according to any one of claims 1 to 3, characterised in that the proportion of PHA in the composition of the layer A is between 2% and 90% by weight, preferably between 3% and 80%, between 4% and 70%, between 5% and 60%, more preferentially between 5% and 40% by weight with respect to the total weight of the composition of the layer A.

5. Multilayer article according to any one of claims 1 to 4, wherein the composition of the layer A furthermore comprises complementary polyesters selected from PBAT (polybutylene adipate terephthalate), PBS (polybutylene succinate), PCL (polycaprolactone), PBSA (polybutylene succinate adipate), plasticised starch and mixtures thereof in any proportions.

6. Multilayer article according to claim 5, wherein the proportion of complementary polymers is between 10% and 90% preferably between 20% and 80%, more preferentially between 30% and 75%, even more preferentially between 40% and 70% by weight with respect to the total weight of the article.

7. Multilayer article according to any one of claims 1 to 6, wherein the layer A furthermore comprises PBAT as complementary polyester.

8. Multilayer article according to any one of claims 1 to 7, characterised in that it comprises, by weight with respect to the total weight of the composition of the article:
i. 10% to 35% PHA, preferably between 12.5 and 25%
ii. 10% to 50% PLA, preferably between 15 and 30%
iii. 50% to 60% PBAT, preferably between 52 and 56%
iv. 0.8% to 8% PCL or PBSA, preferably 4%
v. at least 0.001% enzymes capable of degrading said PLA.

9. Article according to the preceding claim, characterised in that it furthermore comprises a polysaccharide.

10. Multilayer article according to any one of claims 1 to 9, wherein the PHA is selected from the group consisting of PHBV (poly(3-hydroxybutyrate-co-3-hydroxyvalerate)), PHBH (poly(3-hydroxybutyrate-co-3-hydroxyhexanoate)), PHB (poly-β-hydroxybutyrate), PHH (polyhydroxyhexanoate), P3HP (poly(3-hydroxypropionate)), P3HB (poly(3-hydroxybutyrate)), P4HB (poly(4-hydroxybutyrate)), P4HV (poly(4-hydroxyvalerate)), P5HV (poly(5-hydroxyvalerate)), PHB3HP (poly(3-hydroxybutyrate-co-3-hydroxypropionate)), P3HB4HB (poly(3-hydroxybutyrate-co-4-hydroxybutyrate)), PHB4HV (poly(3-hydroxybutyrate-co-4-hydroxyvalerate)), PHB3HV (poly(3-hydroxybutyrate-co-3-hydroxyvalerate)), PHB3HH (poly(3-hydroxybutyrate-co-3-hydroxyhexanoate)), PHB5HV (poly(3-hydroxybutyrate-co-5-hydroxyvalerate)) and mixtures thereof in any proportions.

11. Multilayer article according to any one of claims 1 to 10, characterised in that the layer A and/or the layer B furthermore comprises at least one additive selected from slip additives, plasticisers, nucleating agents, compatibility agents, manufacturing aids, UV radiation stabilisers, impact-protection agents, mineral or vegetable fillers.

12. Multilayer article according to claim 11, characterised in that the proportion of additive, preferably a slip additive, is between 0.2 and 5% by weight, preferably 2% by weight with respect to the total weight of the composition of the article.

13. Multilayer article according to any one of claims 1 to 12, characterised in that the layer C, when present, comprises barrier materials selected from PVOH (polyvinyl alcohol), EVOH (poly(vinyl alcohol-co-ethylene)), PVCD (polyvinyl chloride), PGA (polyglycolic acid), cellulose or polysaccharides and mixtures thereof in any proportions.

14. Multilayer article according to any one of claims 1 to 13, characterised in that it is co-extruded.

15. Multilayer article according to one of claims 1 to 14, characterised in that it has a thickness greater than or equal to approximately 25 μm, to approximately 50 μm, to approximately 450 μm, to approximately 750 μm, and less than or equal to 5000 μm.

16. Multilayer article according to one of claims 1 to 14, characterised in that the thickness of the layer A or of the layer B is between 10 and 725 μm, between 18 and 30 μm, preferably equal to approximately 25 μm.

17. Sheet, characterised in that it comprises a multilayer article according to claims 1 to 16.

18. Sheet, in particular a tray, according to claim 17, characterised in that it has a thickness of less than 5000 μm, preferably between 400 and 800 μm, more preferentially equal to approximately 450 μm, even more preferentially equal to approximately 750 μm.

19. Film, characterised in that it comprises a multilayer article according to any one of claims 1 to 16.

20. Film according to claim 19, characterised in that it has a thickness ranging from 20 to 100 μm, preferably from 25 to 80 μm, more preferentially from 30 to 60 μm, even more preferentially approximately 50 μm.

21. Use of a multilayer article according to any one of claims 1 to 14, for preparing a package, a cap, a beaker, a plate, a drinks cap, a tray or a blister pack.
